(19) United States
(12) Patent Application Publication
(10) Pub. No.: US 2019/0110055 A1
(43) Pub. Date: Apr. 11, 2019

(54) PICTURE STORAGE METHOD AND DISPLAY PANEL

(71) Applicant: HKC Corporation Limited, Shenzhen City (CN)

(72) Inventor: Huailiang He, Shenzhen City (CN)

(21) Appl. No.: 16/141,252

(22) Filed: Sep. 25, 2018

Related U.S. Application Data
(63) Continuation of application No. PCT/CN2017/109766, filed on Nov. 7, 2017.

(30) Foreign Application Priority Data
Oct. 11, 2017 (CN) 201710940530.8

(51) Int. Cl. H04N 19/423; G09G 3/36

(52) U.S. Cl. CPC H04N 19/423; G09G 3/3607; G09G 3/3629

(57) ABSTRACT

The present application discloses a picture storage method and a display panel. The picture storage method includes inputting a current frame picture into a gray scale judging module; judging a gray scale value of the current frame picture, and outputting the current frame picture to a corresponding data compression module; compressing the current frame picture by the data compression module according to a corresponding data compression ratio parameter; and sending the compressed current frame picture to a memory for storage.

### FIELD OF THE DISCLOSURE

The present application relates to the field of display technology, and more particularly to a picture storage method and a display panel.

### BACKGROUND

With technological development and advancement, liquid crystal displays have the advantages of thin bodies, power saving, low radiation, and the like, and thus become a mainstream product of displays, and have become important display platforms of existing IT and video products.

Viewing from a drive principle of the liquid crystal displays, a system main board enables a red/green/blue compression signal and a control signal machine power source to be finally connected to the display area of a display panel by wires, thereby enabling the display panel to obtain required power source and signals.

In order to compare the change of front and back frame pictures in functions such as overvoltage drive, the current picture needs to be stored, and a principle thereof is generally to input the current frame picture into a data compression module and then transmitted into a memory for storage after performing data compression. However, the setting of a data compression ratio in actual application is very important, if the setting of the data compression ratio is too small, then the data required to be stored are excessive, and the cost is increased, while if the setting of the data compression ratio is too large, then errors in compression and decompression processes will be increased and a picture display effect is affected. How to obtain a balance point according to actual picture showing is a problem hard to solve very well.

### SUMMARY

In view of above defects of the background technology, the technical problem to be solved by the present application is to provide a picture storage method and a display panel, which can select different compression ratio parameters according to different conditions of a current frame to compress the current frame picture.

In order to realize the above objective, the present application provides a picture storage method including inputting a current frame picture into a gray scale judging module; judging a gray scale value of the current frame picture, and outputting the current frame picture to a corresponding data compression module; compressing the current frame picture by the data compression module according to a corresponding data compression ratio parameter; and sending the compressed current frame picture to a memory for storage; wherein the data compression module at least includes a high gray scale data compression module and a low gray scale data compression module; the step of judging a gray scale value of the current frame picture, and outputting the current frame picture to a corresponding data compression module includes if the gray scale value of the current frame picture is judged to be a high gray scale, then outputting the current frame picture to the high gray scale data compression module; and if the gray scale value of the current frame picture is judged to be a low gray scale, then outputting the current frame picture to the low gray scale data compression module; wherein a preset data compression ratio of the high gray scale data compression module is larger than that of the low gray scale data compression module; the low gray scale refers to 0-127 gray scales, and the high gray scale refers to 128-255 gray scales; the step of judging a gray scale value of the current frame picture, and outputting the current frame picture to a corresponding data compression module includes detecting the gray scales of all pixels in the current frame picture by the gray scale judging module, and using an average value of the gray scales of all pixels as the gray scale value.

The present application also discloses a picture storage method, including inputting a current frame picture into a gray scale judging module; judging a gray scale value of the current frame picture, and outputting the current frame picture to a corresponding data compression module; compressing the current frame picture by the data compression module according to a corresponding data compression ratio parameter; and sending the compressed current frame picture to a memory for storage.

The present application further discloses a display panel, including a data inputting module, used for inputting a current frame picture; a gray scale judging module, used for receiving the current frame picture and judging a gray scale value thereof; and a data compression module, used for receiving the current frame picture and the corresponding gray scale value, and compressing the current frame picture by adopting a corresponding data compression ratio according to the gray scale value.

According to the picture storage method of the present application, wherein since the data compression ratio parameter of the data compression module is adjustable or selectable, the proper data compression ratio can be selected for compression according to specific conditions of the current frame picture, thereby avoiding the problems that the requirement of data storage is too low and the cost is too high caused by a too small data compression ratio. Meanwhile, the problem that a picture display effect is affected by overlarge errors in compression and decompression processes caused by the too large data compression ratio can also be avoided. Specifically, the present application is provided with the gray scale judging unit to detect the condition of the current frame picture. Since the perception of human eyes for high gray scale and low gray scale pictures is different, different data compression ratio parameters can be selected for data compression according to different gray scales, thereby optimizing a picture storage manner.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a flowchart of a picture storage method according to the present application.

FIG. 2 is a flowchart of an optional picture storage method according to the present application.

FIG. 3 is a flowchart of another optional picture storage method according to the present application.

FIG. 4 is a flowchart of yet another optional picture storage method according to the present application.

FIG. 5 is a schematic diagram of a display panel according to the present application.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

In the description of the disclosure, directional terms used herein such as “up”, “down”, “front”, “back”, “left”, “right”, “inside”, “outside”, “side”, refer only to the directions of the attached drawings. Therefore, the directional terms used herein are intended to illustrate and understand the present disclosure, rather than to limit the present disclosure. In addition, the terms “first” and “second” are only used for descriptive purposes, and are not to be construed as indicating or implying relative importance or implicitly indicating the number of indicated technical features. Thus, features defining “first” and “second” may explicitly or implicitly include one or more of the features. In the description of the present application, “a plurality of” means two or more unless otherwise specified. In addition, the term “comprising” and any variations thereof are intended to cover a non-exclusive inclusion.

In the description of the present application, it should be noted that the terms “installed”, and “connected” should be broadly understood unless otherwise specified and limited. For example, the terms “fixed connection” and “removable” may also be used Connected, or integrally connected; it may be a mechanical connection or an electrical connection; it may be directly connected or indirectly connected through an intermediary medium and may be an internal communication between the two components. For those skilled in the art, the specific meanings of the above terms in this application may be understood in specific cases.

In the description of the disclosure, terms used herein are only for illustrating concrete embodiments rather than limiting the exemplary embodiments. Unless otherwise indicated in the content, singular forms “a” and “an” also include plural. Moreover, the terms “comprise” and/or “include” define the existence of described features, integers, steps, operations, units and/or components, but do not exclude the existence or addition of one or more other features, integers, steps, operations, units, components and/or combinations thereof.

In the figures, the units with similar structures are represented by the same numbers.

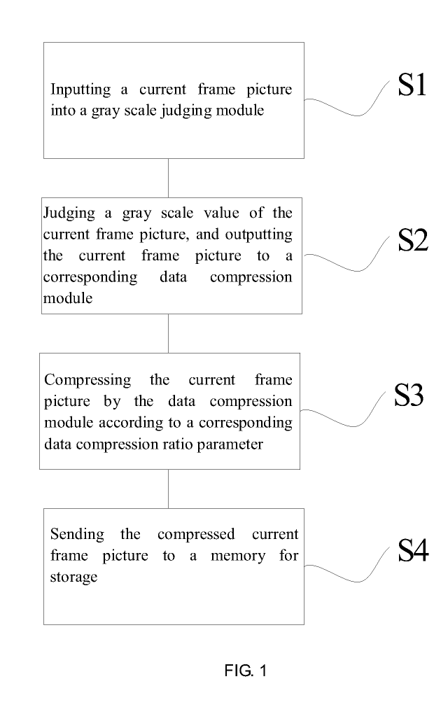

FIG. 1 is a flowchart of a picture storage method according to the present application, referring to FIG. 1, the present application provides the picture storage method, including S1 inputting a current frame picture into a gray scale judging module; S2 judging a gray scale value of the current frame picture, and outputting the current frame picture to a corresponding data compression module; S3 compressing the current frame picture by the data compression module according to a corresponding data compression ratio parameter; and S4 sending the compressed current frame picture to a memory for storage.

According to the picture storage method of the present application, wherein since the data compression ratio parameter of the data compression module is adjustable or selectable, the proper data compression ratio can be selected for compression according to specific conditions of the current frame picture, thereby avoiding the problems that the requirement of data storage is too low and the cost is too high caused by too small data compression ratio. Meanwhile, the problem that a picture display effect is affected by overlarge errors in compression and decompression processes caused by the too large data compression ratio can also be avoided. Specifically, the present application is provided with the gray scale judging unit to detect the condition of the current frame picture. Since the perception of human eyes for high gray scale and low gray scale pictures is different, different data compression ratio parameters can be selected for data compression according to different gray scales, thereby optimizing a picture storage manner.

According to the present embodiment, optionally, the data compression module at least includes a high gray scale data compression module and a low gray scale data compression module.

The step S2 of judging a gray scale value of the current frame picture, and outputting the current frame picture to a corresponding data compression module includes S21 if the gray scale value of the current frame picture is judged to be a high gray scale, then outputting the current frame picture to the high gray scale data compression module; and S22 if the gray scale value of the current frame picture is judged to be a low gray scale, then outputting the current frame picture to the low gray scale data compression module. In the present implementing solution, since the low gray scale picture showing is more sensitive, common compression technologies are often lossy compression, if the compression ratio is large, damage of the image data will be caused, for example, repeated or unimportant data in an image will be lost, as a result, the picture effect of the image obtained after final decompression will be obviously affected, thus it is better to set a smaller compression ratio. The high gray scale is on the contrary, since the high gray scale picture showing is insensitive, even though the image is lost to some extent, there is no obvious influence on the final decompressed image, and on the contrary, if the compression ratio is too small, the increase of a required storage space and cost may be caused. Therefore, the present application divides the data compression module into two parts, and a low gray scale frame picture and a high gray scale frame picture are respectively compressed in a targeted manner, thereby considering both the storage cost and the picture showing effect.

According to the present embodiment, optionally, a preset data compression ratio of the high gray scale data compression module is larger than that of the low gray scale data compression module. In the present implementing solution, the present application divides the data compression module into two parts, wherein the preset data compression ratio of the high gray scale data compression module is larger than that of the low gray scale data compression module, that is, part of the data compression module performs low compression ratio compression on the low gray scale frame picture while the other part of data compression module performs high compression ratio on the high gray scale frame picture, thereby considering both the storage cost and the picture showing effect.

According to the present embodiment, optionally, the low gray scale refers to 0-127 gray scales, and the high gray scale refers to 128-255 gray scales. In the present implementing solution, the ranges of the low gray scales and the high gray scale are respectively 1-127 gray scales and 128-255 gray scales.

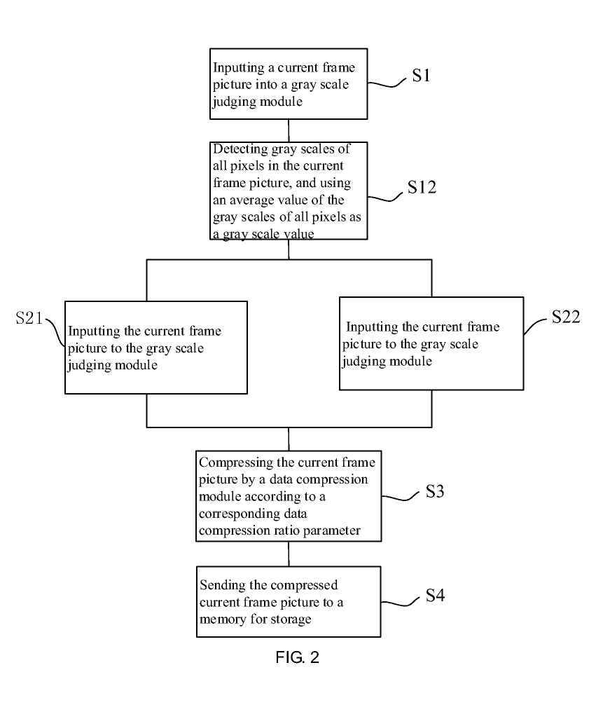

FIG. 2 is a flowchart of an optional picture storage method according to the present application. Referring to FIG. 2, in combination with FIG. 1, according to the present embodiment, optionally, the step S12 of judging a gray scale value of the current frame picture, and outputting the current frame picture to a corresponding data compression module includes detecting the gray scales of all pixels in the current frame picture by the gray scale judging module, and using an average value of the gray scales of all pixels as the gray scale value. In the present implementing solution, the gray scale value of the frame picture is a set including many pixels in fact, the gray scale of each pixel is judged, then the average value is solved, the average value can better embody a main condition of the gray scale forming of the frame picture, in this way, the frame picture obtained by compression and decompression can better consider both the problems of cost and picture effects.

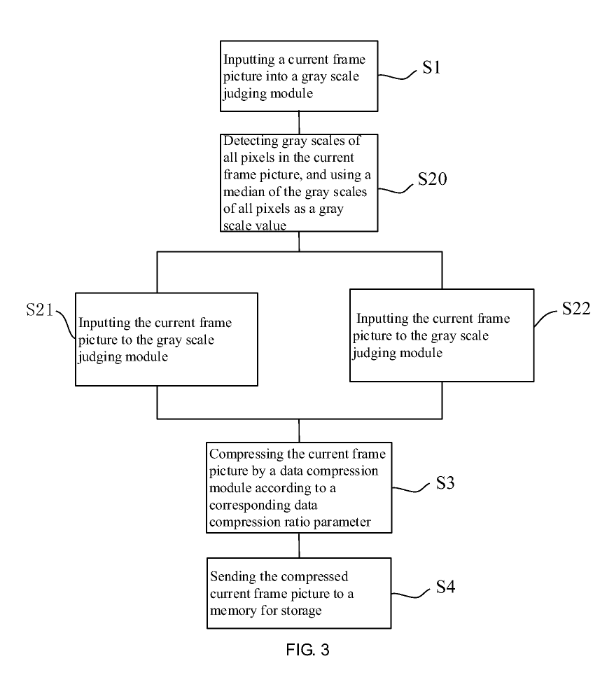

FIG. 3 is a flowchart of another optional picture storage method according to the present application. Referring to FIG. 3, in combination with FIG. 1, it can be known that according to the present embodiment, optionally, the step S20 of judging a gray scale value of the current frame picture, and outputting the current frame picture to a corresponding data compression module includes detecting the gray scales of all pixels in the current frame picture by the gray scale judging module, and using a median of the gray scales of all pixels as the gray scale value. In the present implementing solution, the gray scale value of the frame picture is a set including many pixels in fact, the gray scale of each pixel is judged, then the median is solved, the median can better embody a condition of the gray scale forming of the frame picture, in this way, the frame picture obtained by compression and decompression can better consider both the problems of cost and picture effects.

According to the present embodiment, optionally, the data compression module adopts a software compression technology or hardware compression technology. In the present implementing solution, the data compression module may adopt the software compression technology, the compatibility of the software compression technology is better, and can perform targeted compression on formats of all transmitted frame pictures. The processing effect can be improved if the hardware compression technology is adopted as long as input formats of the frame picture are limited.

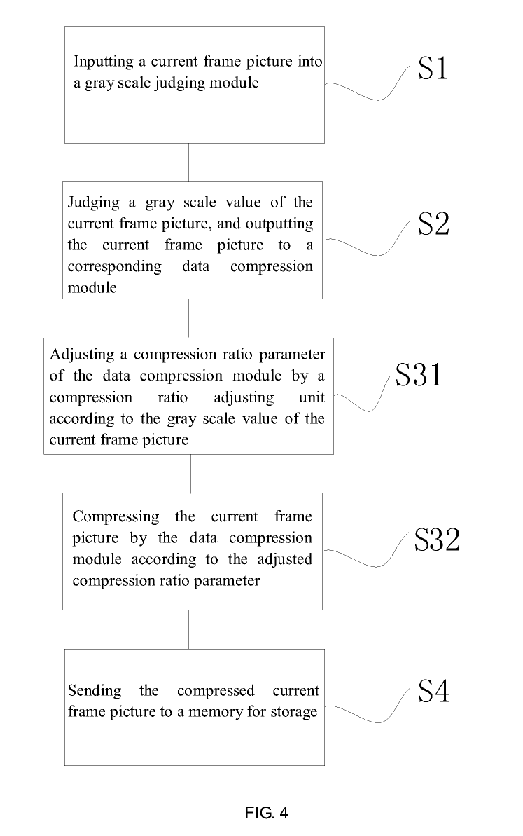

FIG. 4 is a flowchart of yet another optional picture storage method according to the present application. Referring to FIG. 4, in combination with FIG. 1, it can be known that according to the present embodiment, optionally, the wherein the data compression module includes a compression ratio adjusting unit.

The step S3 of compressing the current frame picture by the data compression module according to the preset data compression ratio includes the step S32 adjusting a compression ratio parameter of the data compression module by the compression ratio adjusting unit according to the gray scale value of the current frame picture; and compressing the current frame picture by the data compression module according to the adjusted compression ratio parameter. In the present implementing solution, the data compression module is provided with the compression ratio adjusting unit instead of being divided, and the compression ratio adjusting unit adjusts the compression ratio of the data compression module according to input different gray scale values.

According to the present embodiment, optionally, the data compression module at least includes a high gray scale data compression module, a middle gray scale data compression module and a low gray scale data compression module.

The step S2 of judging a gray scale value of the current frame picture, and outputting the current frame picture to a corresponding data compression module includes if the gray scale value of the current frame picture is judged to be a high gray scale, then outputting the current frame picture to the high gray scale data compression module; if the gray scale value of the current frame picture is judged to be a middle gray scale, then outputting the current frame picture to the middle gray scale data compression module; and if the gray scale value of the current frame picture is judged to be a low gray scale, then outputting the current frame picture to the low gray scale data compression module. In the present implementing solution, the low gray scale picture showing is more sensitive, and the large compression ratio will affect the picture effect, thus the smaller compression ratio is set, while for the high gray scale, the compression ratio can be properly increased to reduce the storage cost. Therefore, the present application divides the data compression module into the low gray scale part, the middle gray scale and the high gray scale part, and the low gray scale frame picture, the middle gray scale frame picture and the high gray scale frame picture are respectively compressed in a target manner, thereby considering both the storage cost and the picture showing effect. Wherein the range of the low gray scales is 0-82 gray scales, the range of the middle gray scales is 83-166 gray scales and the range of the high gray scales is 167-255 gray scales.

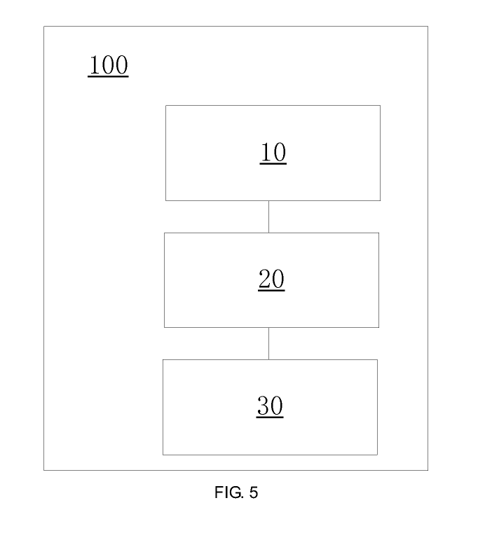

FIG. 5 is a schematic diagram of a display panel according to the present application. Referring to FIG. 2, in combination with FIG. 1, it can be known that the present application further discloses a display panel 100, including a data inputting module 10, used for inputting a current frame picture; a gray scale judging module 20, used for receiving the current frame picture and judging a gray scale value thereof; and a data compression module 30, used for receiving the current frame picture and the corresponding gray scale value, and compressing the current frame picture by adopting a corresponding data compression ratio parameter according to the gray scale value.

The display panel of the present application adopts the novel picture storage method, wherein since the data compression ratio parameter of the data compression module is adjustable or selectable, the proper data compression ratio can be selected for compression according to specific conditions of the current frame picture, thereby avoiding the problems that the requirement of data storage is too low and the cost is too high caused by too small data compression ratio. Meanwhile, the problem that a picture display effect is affected by overlarge errors in compression and decompression processes caused by the too large data compression ratio can also be avoided. Specifically, the present application is provided with the gray scale judging unit to detect the condition of the current frame picture. Since the perception of human eyes for high gray scale and low gray scale pictures is different, different data compression ratio parameters can be selected for data compression according to different gray scales, thereby optimizing a picture storage manner.

According to the present embodiment, optionally, the data compression module 30 at least includes a high gray scale data compression module and a low gray scale data compression module.

If the gray scale value of the current frame picture is judged to be a high gray scale by the gray scale judging module 20, then the data inputting module outputs the current frame picture to the high gray scale data compression module.

If the gray scale value of the current frame picture is judged to be a low gray scale by the gray scale judging module 20, then the data inputting module outputs the current frame picture to the low gray scale data compression module.

According to the present embodiment, optionally, the preset data compression ratio of the high gray scale data compression module is larger than that of the low gray scale data compression module.

The low gray scale refers to 0-127 gray scales, and the high gray scale refers to 128-255 gray scales.

The gray scale judging module 20 detects the gray scales of all pixels in the current frame picture, and uses an average value of the gray scales of all pixels as the gray scale value.

According to the present embodiment, optionally, the preset data compression ratio of the high gray scale data compression module is larger than that of the low gray scale data compression module

The low gray scale refers to 0-127 gray scales, and the high gray scale refers to 128-255 gray scales.

The gray scale judging module detects the gray scales of all pixels in the current frame picture, and uses a median of the gray scales of all pixels as the gray scale value.

According to the present embodiment, optionally, the data compression module 30 adopts a software compression technology or hardware compression technology.

According to the present embodiment, optionally, the data compression module 30 includes a compression ratio adjusting unit.

The compression ratio adjusting unit adjusts the compression ratio parameter of the data compression module according to the gray scale value of the current frame picture.

The data compression module compresses the current frame picture according to the adjusted compression ratio parameter.

According to the present embodiment, optionally, the data compression module 30 at least includes a high gray scale data compression module, a middle gray scale data compression module and a low gray scale data compression module.

If the gray scale value of the current frame picture is judged to be a high gray scale by the gray scale judging module 20, then the current frame picture is output to the high gray scale data compression module.

If the gray scale value of the current frame picture is judged to be a middle gray scale by the gray scale judging module 20, then the current frame picture is output to the middle gray scale data compression module.

If the gray scale value of the current frame picture is judged to be a low gray scale by the gray scale judging module 20, then the current frame picture is output to the low gray scale data compression module.

The panel of the present application may be a twisted nematic (TN) panel, an in-plane switching (IPS) panel and a multi-domain vertical alignment (VA) panel, and of course may also be other types of panels as long as they are applicable.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A picture storage method, comprising
inputting a current frame picture into a gray scale judging module;
judging a gray scale value of the current frame picture, and outputting the current frame picture to a corresponding data compression module;
compressing the current frame picture by the data compression module according to a corresponding data compression ratio parameter; and
sending the compressed current frame picture to a memory for storage;
wherein the data compression module at least comprises a high gray scale data compression module and a low gray scale data compression module;
wherein the step of judging a gray scale value of the current frame picture, and outputting the current frame picture to a corresponding data compression module comprises
outputting the current frame picture to the high gray scale data compression module if the gray scale value of the current frame picture is judged to be a high gray scale; and
outputting the current frame picture to the low gray scale data compression module if the gray scale value of the current frame picture is judged to be a low gray scale;
wherein a preset data compression ratio of the high gray scale data compression module is larger than that of the low gray scale data compression module; the low gray scale refers to 0-127 gray scales, and the high gray scale refers to 128-255 gray scales; the step of judging a gray scale value of the current frame picture, and outputting the current frame picture to a corresponding data compression module comprises
detecting the gray scales of all pixels in the current frame picture by the gray scale judging module, and using an average value of the gray scales of all pixels as the gray scale value.

2. A picture storage method, comprising
inputting a current frame picture into a gray scale judging module;
judging a gray scale value of the current frame picture, and outputting the current frame picture to a corresponding data compression module;
compressing the current frame picture by the data compression module according to a corresponding data compression ratio parameter; and
sending the compressed current frame picture to a memory for storage.

3. The picture storage method according to claim 2, wherein the data compression module at least comprises a high gray scale data compression module and a low gray scale data compression module;
the step of judging a gray scale value of the current frame picture, and outputting the current frame picture to a corresponding data compression module comprises
if the gray scale value of the current frame picture is judged to be a high gray scale, then outputting the current frame picture to the high gray scale data compression module; and
if the gray scale value of the current frame picture is judged to be a low gray scale, then outputting the current frame picture to the low gray scale data compression module.

4. The picture storage method according to claim 3, wherein a preset data compression ratio of the high gray scale data compression module is larger than that of the low gray scale data compression module.

5. The picture storage method according to claim 3, wherein the low gray scale refers to 0-127 gray scales, and the high gray scale refers to 128-255 gray scales.

6. The picture storage method according to claim 3, wherein the step of judging a gray scale value of the current frame picture, and outputting the current frame picture to a corresponding data compression module comprises
detecting the gray scales of all pixels in the current frame picture by the gray scale judging module, and using an average value of the gray scales of all pixels as the gray scale value.

7. The picture storage method according to claim 3, wherein the step of judging a gray scale value of the current frame picture, and outputting the current frame picture to a corresponding data compression module comprises
detecting the gray scales of all pixels in the current frame picture by the gray scale judging module, and using a median of the gray scales of all pixels as the gray scale value.

8. The picture storage method according to claim 3, wherein a preset data compression ratio of the high gray scale data compression module is larger than that of the low gray scale data compression module;
the low gray scale refers to 0-127 gray scales, and the high gray scale refers to 128-255 gray scales;
the step of judging a gray scale value of the current frame picture, and outputting the current frame picture to a corresponding data compression module comprises
detecting the gray scales of all pixels in the current frame picture by the gray scale judging module, and using an average value of the gray scales of all pixels as the gray scale value.

9. The picture storage method according to claim 3, wherein a preset data compression ratio of the high gray scale data compression module is larger than that of the low gray scale data compression module;
the low gray scale refers to 0-127 gray scales, and the high gray scale refers to 128-255 gray scales;
the step of judging a gray scale value of the current frame picture, and outputting the current frame picture to a corresponding data compression module comprises
detecting the gray scales of all pixels in the current frame picture by the gray scale judging module, and using a median of the gray scales of all pixels as the gray scale value.

10. The picture storage method according to claim 2, wherein the data compression module adopts a software compression technology or hardware compression technology.

11. The picture storage method according to claim 2, wherein the data compression module comprises a compression ratio adjusting unit;
the data compression module compresses the current frame picture according to a preset data compression ratio, and a step of compressing the current frame picture comprises
adjusting a compression ratio parameter of the data compression module by the compression ratio adjusting unit according to the gray scale value of the current frame picture; and
compressing the current frame picture by the data compression module according to the adjusted compression ratio parameter.

12. The picture storage method according to claim 2, wherein the data compression module at least comprises a high gray scale data compression module, a middle gray scale data compression module and a low gray scale data compression module;
the step of judging a gray scale value of the current frame picture, and outputting the current frame picture to a corresponding data compression module comprises
if the gray scale value of the current frame picture is judged to be a high gray scale, then outputting the current frame picture to the high gray scale data compression module;
if the gray scale value of the current frame picture is judged to be a middle gray scale, then outputting the current frame picture to the middle gray scale data compression module; and
if the gray scale value of the current frame picture is judged to be a low gray scale, then outputting the current frame picture to the low gray scale data compression module.

13. A display panel, comprising
a data inputting module, used for inputting a current frame picture;
a gray scale judging module, used for receiving the current frame picture and judging a gray scale value thereof; and
a data compression module, used for receiving the current frame picture and the corresponding gray scale value, and compressing the current frame picture by adopting a corresponding data compression ratio parameter according to the gray scale value.

14. The display panel according to claim 13, wherein the data compression module at least comprises a high gray scale data compression module and a low gray scale data compression module;
if the gray scale value of the current frame picture is judged to be a high gray scale, then the data inputting module outputs the current frame picture to the high gray scale data compression module; and
if the gray scale value of the current frame picture is judged to be a low gray scale, then the data inputting module outputs the current frame picture to the low gray scale data compression module.

15. The display panel according to claim 14, wherein a preset data compression ratio of the high gray scale data compression module is larger than that of the low gray scale data compression module;
the low gray scale refers to 0-127 gray scales, and the high gray scale refers to 128-255 gray scales;
the gray scale judging module detects the gray scales of all pixels in the current frame picture, and uses an average value of the gray scales of all pixels as the gray scale value.

16. The display panel according to claim 14, wherein a preset data compression ratio of the high gray scale data compression module is larger than that of the low gray scale data compression module;
the low gray scale refers to 0-127 gray scales, and the high gray scale refers to 128-255 gray scales;
the gray scale judging module detects the gray scales of all pixels in the current frame picture, and uses a median of the gray scales of all pixels as the gray scale value.

17. The display panel according to claim 13, wherein the data compression module adopts a software compression technology or hardware compression technology.

18. The display panel according to claim 13, wherein the data compression module comprises a compression ratio adjusting unit;
the compression ratio adjusting unit adjusts the compression ratio parameter of the data compression module according to the gray scale value of the current frame picture; and
the data compression module compresses the current frame picture according to the adjusted compression ratio parameter.

19. The display panel according to claim 13, wherein the data compression module at least comprises a high gray scale data compression module, a middle gray scale data compression module and a low gray scale data compression module;
if the gray scale value of the current frame picture is judged to be a high gray scale by the gray scale judging module, then the current frame picture is output to the high gray scale data compression module;
if the gray scale value of the current frame picture is judged to be a middle gray scale by the gray scale judging module, then the current frame picture is output to the middle gray scale data compression module; and
if the gray scale value of the current frame picture is judged to be a low gray scale by the gray scale judging module, then the current frame picture is output to the low gray scale data compression module.

20. The display panel according to claim 13, wherein the data compression module at least comprises a high gray scale data compression module and a low gray scale data compression module;
if the gray scale value of the current frame picture is judged to be a high gray scale by the gray scale judging module, then the data inputting module outputs the current frame picture to the high gray scale data compression module; and
if the gray scale value of the current frame picture is judged to be a low gray scale by the gray scale judging module, then the data inputting module outputs the current frame picture to the low gray scale data compression module;
a preset data compression ratio of the high gray scale data compression module is larger than that of the low gray scale data compression module;
the low gray scale refers to 0-127 gray scales, and the high gray scale refers to 128-255 gray scales; and
the gray scale judging module judges the gray scales of all pixels in the current frame picture, and uses an average value of the gray scales of all pixels as the gray scale value.
